(19) United States
(12) Patent Application Publication
(10) Pub. No.: US 2024/0418097 A1
(43) Pub. Date: Dec. 19, 2024

(54) LABYRINTH SEALING DEVICE FOR AN AIRCRAFT TURBOMACHINE

(71) Applicant: SAFRAN AIRCRAFT ENGINES, Paris (FR)

(72) Inventors: Michael Piers HANSOM, MOISSY-CRAMAYEL (FR); Antoine Robert Alain BRUNET, MOISSY-CRAMAYEL (FR); Olivier Jean-Daniel BAUMAS, MOISSY-CRAMAYEL (FR)

(73) Assignee: SAFRAN AIRCRAFT ENGINES, Paris (FR)

(21) Appl. No.: 18/706,930

(22) PCT Filed: Nov. 2, 2022
(86) PCT No.: PCT/FR2022/052063

§ 371 Date: May 2, 2024

(30) Foreign Application Priority Data
Nov. 5, 2021 (FR) 2111775

(51) Int. Cl. F01D 11/02; F01D 11/12

(52) U.S. Cl. CPC F01D 11/02; F01D 11/122

(57) ABSTRACT

A labyrinth-type sealing device for an aircraft turbomachine includes a rotor with at least one external annular lip. The device further includes a stator with an annular coating made of abradable material with extends around the lip and which is configured to cooperate in operation with the lip in order to form a labyrinth-type seal with respect to a flow of gas flowing through the rotor axially from upstream to downstream. The coating has an internal cylindrical surface that extends around the lip and is configured to contact the lip in order to form, by friction, an annular groove, and, upstream of the lip, a preformed annular slot.

### TECHNICAL FIELD OF THE INVENTION

This invention relates to a labyrinth-type sealing device for an aircraft turbomachine, and to an aircraft turbomachine comprising such a device.

### TECHNICAL BACKGROUND

The technical background comprises in particular the documents FR-A1-2 825 411, FR-A1-3 071 540, FR-A1-3 072 413, US-A1-2018/355745, EP-A1-3 344 901, and FR-A1-3 068 070.

In an aircraft turbomachine, a labyrinth-type sealing device typically comprises a rotor comprising at least one external annular lip, and a stator comprising an annular coating made of abradable material which extends around the lip and which is configured to cooperate in operation with the lip. The friction of the lip on the coating creates an annular groove in the coating and the lip is intended to be housed in this groove to reduce plays between the rotor and stator and thereby form a seal between the rotor and the stator with respect to a gas flow flowing axially in the turbomachine and through the rotor.

In the present application, upstream and downstream are defined in relation to the normal direction of flow of the gas flows (from upstream to downstream) in the turbomachine. This flow takes place along an axis of the turbomachine, which is the axis of rotation of the rotor. The axial direction corresponds to the direction of the axis of the turbomachine, and a radial direction is a direction perpendicular to the axis of the turbomachine and intersecting that axis. Similarly, an axial plane is a plane containing the axis of the turbomachine, and a radial plane is a plane perpendicular to that axis. The adjectives “internal” and “external” are used in reference to a radial direction so that the internal part of an element is, along a radial direction, closer to the axis of the turbomachine than the external part of the same element.

An aircraft turbomachine may comprise one or more sealing devices of the above type, for example in a compressor or turbine of the turbomachine.

For example, a sealing device is commonly used at the periphery of a rotor blading of a compressor or turbine (conventional or contra-rotating, for example), as shown in FIG. 1. This blading 10 comprises one or more annular lips 12 on its external periphery, which are oriented radially towards the outside and can be inclined axially. As the blading 10 rotates, these lips 12 form grooves 14 in the abradable coating 16 fixed to a casing 18 (see FIGS. 1 and 2). This coating 16 is generally in the form of a honeycomb structure (called “Nida”) and comprises radially oriented cells. This structure provides axial sealing while reducing resistance to cutting in the tangential direction. Once the grooves 14 are formed in the coating 16, the plays between the lips 12 and the coating 16 can be controlled by a ventilation system 20 of the casing 18 in the case of a turbine, in order to minimise the plays between the rotor and the stator, and thus reduce leakage and improve the performance of the turbomachine.

When the lips 12 contacts the coating 16 during the formation of the grooves 14, a cutting and/or frictional force is generated. This force in the tangential direction is applied to the vanes 22 of the blading 10 and can vary according to the hardness of the coating 16 and the lips 12, of the size of the surfaces in contact and the speed of penetration of the lips 12 into the coating 16.

The tangential force applied to the lips 12 of the vanes 22 causes the blade to bend, resulting in a decambering effect and an increase in the radius of the top of the lips 12. As the radius of the lips 14 increases, the penetration of the coating 16 and therefore the tangential force also increases. This phenomenon is known as self-engagement of the vanes 22 and is illustrated schematically by arrow F1 in FIG. 2.

The geometry of the vanes 22, and in particular the pitch and curvature of their blades, has the effect of generating an upstream displacement of the top of the vanes 22 when a purely tangential force is applied. Thus, in addition to an increase in the radius of the lips 14, an advance of them with respect to the coating 16 is produced when a tangential force is applied (see arrow F2 in FIG. 3). The lips 12 thus arrive in an area of the coating 16 that has not yet been worn away, which further increases the tangential force applied. A divergent phenomenon is therefore set up which only stops when the lips 12 are no longer in contact with the coating 16, or when axial contact with another part stops the advance of the vane 22 (contact, for example, at C1 in FIG. 4 between a heel 24 of the vane 22 and a turbine stator 26 located upstream), a breakage of one or more parts, or a stoppage of the turbomachine. This phenomenon is known as “wandering” of the blading 10.

When the wandering phenomenon starts, it can result in damage to the vanes 22 and rotor-stator contact between the vanes 22 and the turbine stators 26. This damage leads to premature dismantling and replacement of parts, and therefore very costly maintenance operations.

Several solutions have been implemented to address this technical problem, but they are not entirely satisfactory.

The present invention proposes a simple, effective and economical solution to this problem.

### SUMMARY OF THE INVENTION

The invention relates to a labyrinth-type sealing device for an aircraft turbomachine, the device comprising:
a rotor having an axis of rotation and comprising external annular lips extending around said axis, and
a stator extending around the axis, this stator comprising an annular coating made of abradable material which extends around the lips and which is configured to cooperate in operation with the lips to form a labyrinth-type seal with respect to a flow of gas which is intended to flow axially from upstream to downstream through the rotor, the coating comprising an internal cylindrical surface extending around the lips and which is able to contact the lips to form annular grooves extending around the axis by friction,
characterised in that said surface comprises, upstream of each of the lips, a preformed annular slot which extends around the axis and which is able to receive said lip in the event of axial upstream displacement of the rotor with respect to the stator, the number of preformed slots being equal to the number of lips of the rotor.

In the present application, a distinction is made between a groove that is formed by a lip rubbing against the coating during the operation of the turbomachine, and a slot that is pre-formed in the coating during its manufacture. In other words, if the device comprises a new coating (never used in a turbomachine), this coating will only comprise one or more slots. In the case of a device already used in a turbomachine, the coating of this device would comprise at least one slot and at least one groove.

In the normal operating position of the rotor relative to the stator, the groove formed by a lip is located in line with the lip or its external periphery. This means that the groove and the lip (or its periphery) are located in the same plane perpendicular to the axis. On the other hand, the slot is located upstream of the groove and the lip and is preferably located at a predetermined axial distance so as to avoid or limit the above-mentioned wandering phenomenon.

If the rotor or part of the rotor were to move axially upstream, the lip would become housed in the preformed slot. This slot interrupts the contact between the lip and the coating and slows or stops this axial travel, thereby limiting the phenomenon of wandering. This avoids the risk of the rotor damage and rotor-stator contact.

The slot thus has a function of limiting incursion and force (in the event of violent contact between the lips and the abradable coating), advantageously during normal operation of the engine from idle to full throttle.

In contrast, in the prior art, slots or grooves are located downstream or in the middle of the lips. These slots or grooves have particular shapes and generally have a pressure drop (performance) function.

The device according to the invention may comprise one or more of the following characteristics, taken independently of one another or in combination with one another:
the rotor comprises at least one upstream lip and one downstream lip, the upstream and downstream lips being surrounded by the same cylindrical surface of the coating or by two distinct cylindrical surfaces, respectively upstream and downstream, of the coating;
the cylindrical surface extending around the upstream and downstream lips comprises a preformed slot upstream of the upstream lip and/or a preformed slot upstream of the downstream lip;
the upstream cylindrical surface comprises a preformed slot upstream of the upstream lip, and/or the downstream cylindrical surface comprises a preformed slot upstream of the downstream lip;
the upstream and downstream cylindrical surfaces are stepped and comprise different diameters;
the slot is interposed axially between the two cylindrical surfaces;
each slot is located at an axial distance upstream from the corresponding lip, which is less than or equal to half the axial distance between the two lips;
alternatively, each slot is located at an axial distance upstream from the corresponding lip, which is greater than half the axial distance between the two lips;
the axial distance is between 1 and 20 mm, and preferably between 1 and 5 mm, or even more on certain large engines;
each slot has a radial depth or dimension less than or equal to a radial thickness or dimension of an area of the coating in which this slot is formed;
each slot has an axial dimension greater than or equal to half an axial thickness of the corresponding lip, this thickness being measured at an external periphery of this lip;
each slot is located at an axial distance from an upstream axial end of the cylindrical surface in which the slot is formed;
the rotor is a compressor or turbine blading, and the stator is a sealing ring carried by a casing of this compressor or turbine.

The invention also relates to an aircraft turbomachine, comprising at least one device as described above.

### BRIEF DESCRIPTION OF THE FIGURES

Further characteristics and advantages of the invention will become apparent from the following detailed description, for the understanding of which reference is made to the attached drawings in which:

FIG. 1 is a partial schematic view in axial section of a sealing device for an aircraft turbomachine, according to the technique prior to the present invention;

FIG. 2 is a similar view to FIG. 1 and illustrates the formation of grooves by lips of the device in an abradable coating of the device;

FIG. 3 is a similar view to FIG. 1 and illustrates the upstream axial displacement of the rotor relative to the stator of the device;

FIG. 4 is a similar view to FIG. 1 and illustrates the axial contact between the rotor of the device and a stator of the turbomachine;

FIG. 5 is a partial schematic view in axial section of a sealing device for an aircraft turbomachine, according to a first embodiment of the invention;

FIG. 6a is a similar view to FIG. 5 and illustrates a rest position of the device;

FIG. 6b is a similar view to FIG. 5 and illustrates a first operating position of the device;

FIG. 6c is a similar view to FIG. 5 and illustrates a second operating position of the device;

FIG. 6d is a similar view to FIG. 5 and illustrates a third operating position of the device;

FIG. 6e is a view similar to FIG. 5 and illustrates a fourth operating position of the device;

FIG. 7 is a similar view to FIG. 5 and illustrates a second embodiment of the invention;

FIG. 8 is a similar view to FIG. 5 and illustrates a third embodiment of the invention;

FIG. 9 is a similar view to FIG. 5 and illustrates a fourth embodiment of the invention;

FIG. 10 is a similar view to FIG. 5 and illustrates a fifth embodiment of the invention;

FIG. 11 is a similar view to FIG. 5 and illustrates a sixth embodiment of the invention.

### DETAILED DESCRIPTION OF THE INVENTION

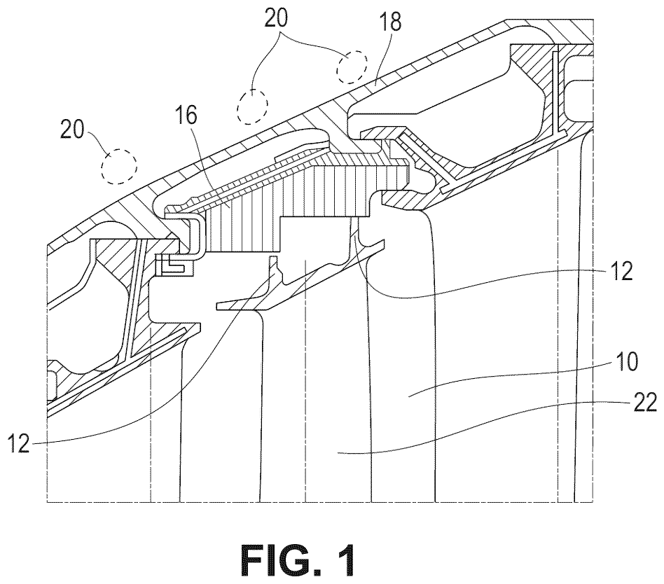

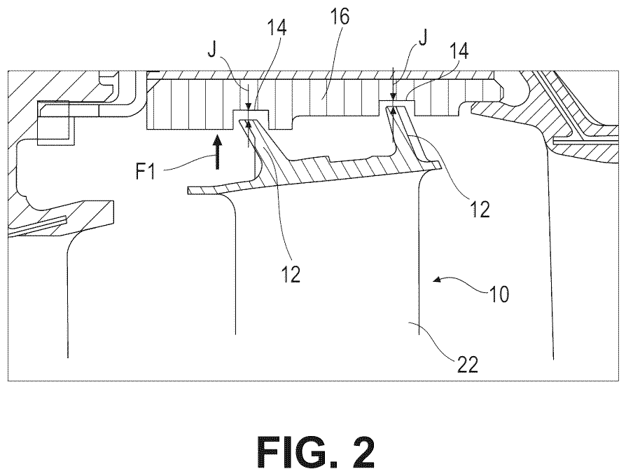

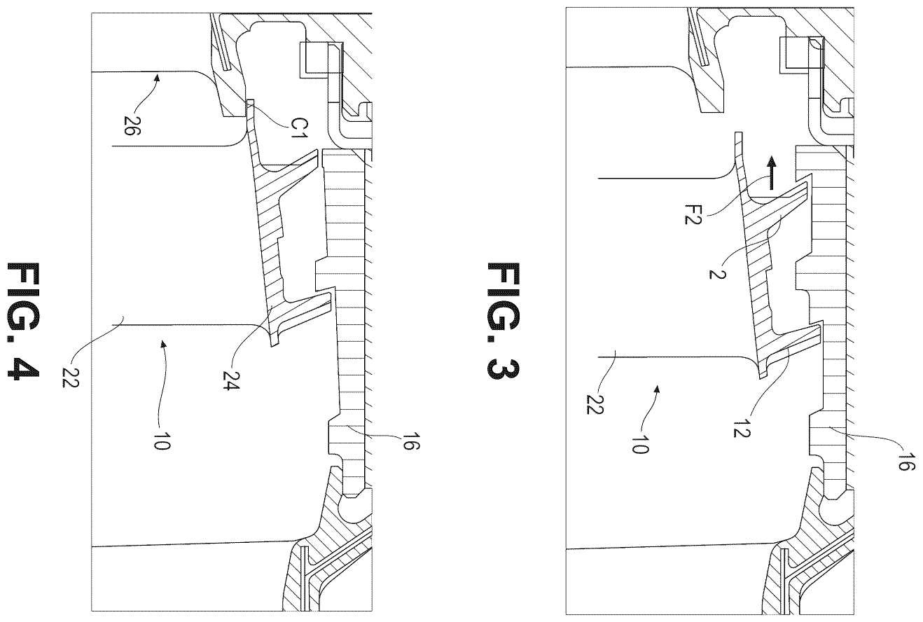

FIGS. 1 to 4 have been described above.

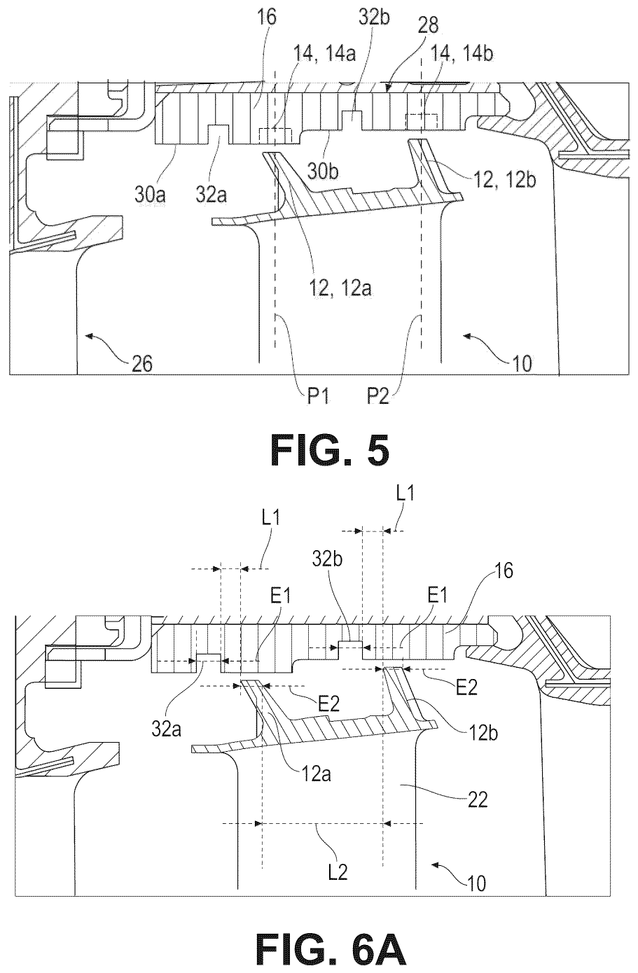

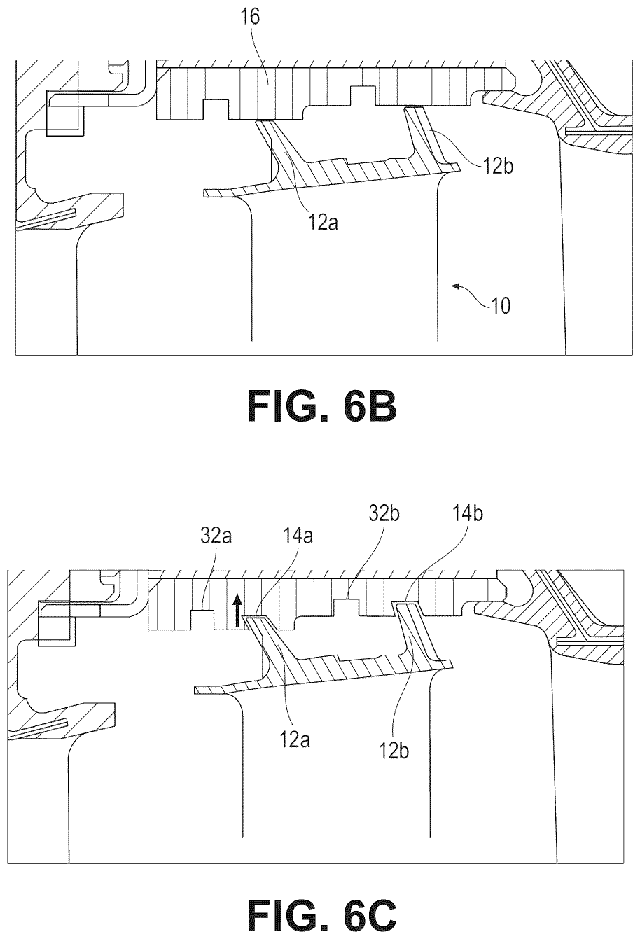

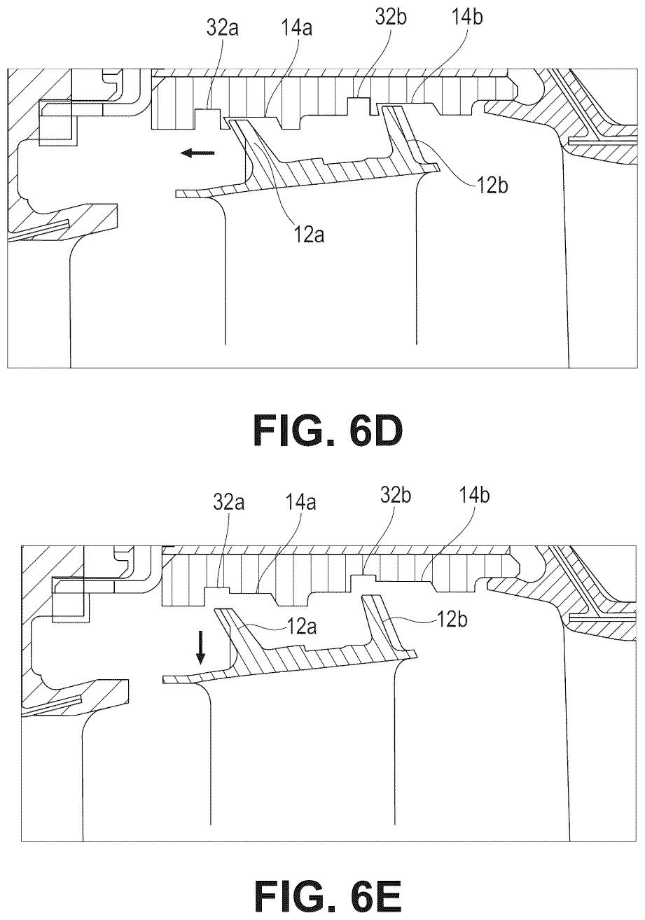

FIG. 5 illustrates a first embodiment of a sealing device according to the invention and FIGS. 6a to 6e illustrate the operation of this device.

FIG. 5 is a partial view of a turbomachine and shows a compression stage of a compressor or an expansion stage of a turbine of this turbomachine.

This stage comprises a stator blading known as the turbine stator 26 and a rotor blading 10 located downstream of the turbine stator 26. The turbine stator 26 is attached to a casing 18 which is annular in shape and extends around the stage.

The rotor blading 10, also known as the “rotor”, is mobile in rotation about an axis that is not visible in the drawing. The blading 10 comprises a plurality of vanes 22 and comprises at least one annular lip 12 oriented radially outwards on its external periphery. In the example shown, the rotor comprises two lips 12 located at an axial distance from each other and referred to respectively as the upstream lip 12a and the downstream lip 12b.

The casing 18 extends around the blading 10 and carries a sealing ring 28 which can be sectorised. This ring 28 comprises an internal annular coating 16 which surrounds the external periphery of the blading 10 and therefore extends around the lips 12.

The coating 16 is made of an abradable material and comprises, for example, a honeycomb structure, i.e. a structure comprising cells which are preferably oriented in a radial direction with respect to the aforementioned axis. This type of structure is well known to those skilled in the art. Alternatively, the coating 16 could be solid.

The coating 16 comprises at least one internal cylindrical surface 30a, 30b which extends around the lips 12. The number of surfaces 30a, 30b may be equal to the number of lips 12, and may be two as in the example shown, so that each of the surfaces 30a, 30b extends around one of the lips 12. The coating 16 thus comprises an upstream cylindrical surface 30a around the upstream lip 12a and a downstream cylindrical surface 30b around the downstream lip 12b.

Each of the lips 12 is oriented radially outwards and can be inclined, for example from downstream to upstream radially outwards, as in the example shown.

In operation, the lips 12 contact the coating 16 and their surfaces 30a, 30b and create annular grooves 14 by friction and wear of the abradable material 16. The grooves 14 are therefore formed during operation and in particular during initial operation of the turbomachine.

The surfaces 30a, 30b can be stepped and have different diameters. In the example shown, the upstream surface 30a has a diameter smaller than the diameter of the downstream surface 30b.

The coating 16 comprises a groove (upstream) 14a formed in the upstream surface 30a, and a groove (downstream) 14b formed in the downstream surface 30b. In the normal operating position as illustrated in FIG. 5, the grooves 14a, 14b are located respectively in line with lips 12a, 12b and in particular their external peripheries, which means that the groove 14a and the lip 12a are located substantially in the same plane P1 perpendicular to the axis, and that groove 14b and lip 12b are located substantially in the same other plane P2 perpendicular to the axis.

To avoid or limit the above-mentioned wandering phenomenon, the invention proposes to preform at least one annular slot 32a, 32b in the coating 16, upstream of the or each lip 12. It is thus understood that this type of slot 32a, 32b is formed in the coating 16 during its manufacture and is therefore not generated during the operation of the turbomachine, unlike the grooves 30a, 30b.

In the embodiment shown in FIG. 5, the coating 16 comprises two slots 32a, 32b. In other words, the number of slots 32a, 32b is equal to the number of lips 12a, 12b. The coating 16 comprises a slot (upstream) 32a upstream of the upstream lip 12a and formed in the upstream surface 30a, and a slot (downstream) 32b upstream of the downstream lip 12b and formed in the downstream surface 30b. FIG. 6a is similar to FIG. 5 and illustrates the axial position of the rotor with respect to the stator when the turbomachine is at rest, before it is used for the first time. The blading 10 is at a radial distance from the coating 16.

During an initial operation of the turbomachine, the lips 12a, 12b rub against and wear away the coating 16 (FIGS. 6b and 6c), creating the aforementioned annular grooves 14a, 14b. FIGS. 6a and 6b show that the slots 32a, 32b are already present in the coating 16 and that the grooves 14a, 14b are distinct from these slots 32a, 32b.

During a wandering phenomenon, the vanes 22 of the blading 10 tend to move upstream (FIG. 6d). The lips 12a, 12b will then widen the grooves 14a, 14b, further wearing the coating 16 in the axial direction. The slots 32a, 32b are located upstream and at a predetermined distance from the grooves 14a, 14b and the lips 12a, 12b so as to stop the axial movement of the rotor as soon as possible. When the lips 12a, 12b reach the slots 32a, 32b, there is no longer any contact between the lips 12a, 12b and the coating 16, which slows and stops the axial movement of the rotor, thus preventing an axial contact between the rotor and the stator (FIG. 6e).

The purpose of the slots 32a, 32b is therefore to receive the lips 12a, 12b in the event of axial upstream displacement of the rotor with respect to the stator, in order to avoid or limit the phenomenon of wandering.

Preferably, the or each slot 32a, 32b is located at an axial distance L1 upstream of the corresponding lip 12a, 12b, which is less than or equal to half the axial distance L2 between the two lips 12a, 12b (see FIG. 6a). L1 is preferably between 1 and 5 mm.

The or each slot 32a, 32b has an axial dimension E1 which is preferably greater than or equal to half an axial thickness E2 of the corresponding lip 12a, 12b, this thickness E2 being measured at an external periphery of this lip (see FIG. 6a).

The or each slot 32a, 32b may be of any shape and, for example, may be square or rectangular in cross-section, as in the example shown, or round, oval, etc.

The bottom of the or each slot 32a, 32b, i.e. the wall at the bottom of the or each slot, may be of any shape, flat, curved or other.

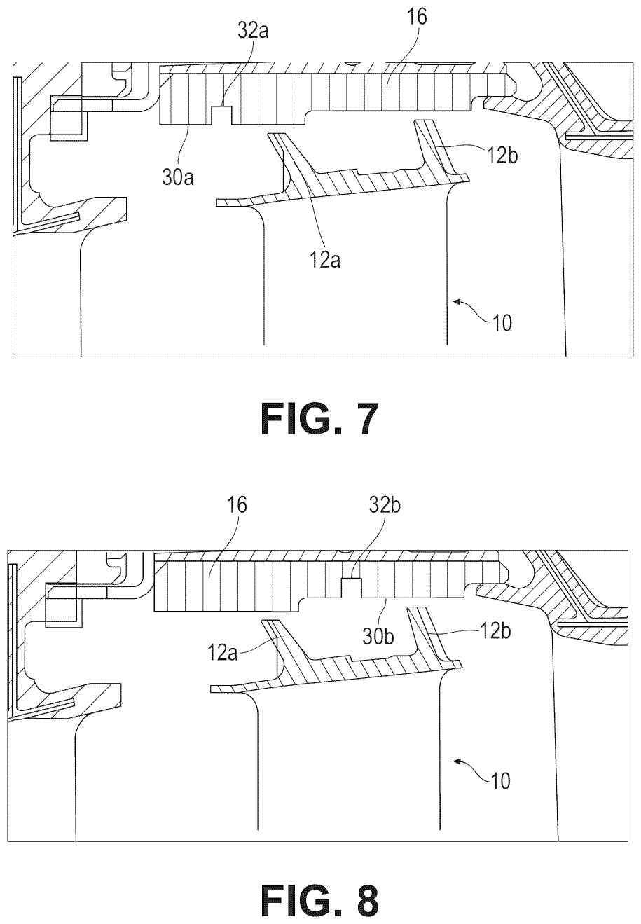

FIGS. 7 and 8 illustrate alternative versions of the device in which the number of preformed slots in the coating 16 is less than the number of lips 12a, 12b, and in this case is one. In FIG. 7, the coating 16 comprises an upstream slot 32a formed in the upstream surface 30a upstream of the upstream lip 12a. In FIG. 8, the coating 16 comprises a downstream slot 32b formed in the downstream surface 30b upstream of the downstream lip 12b. These variations show that a single slot can be sufficient to receive one of the lips and avoid the wandering phenomenon. Even if only one of the two lips 12a, 12b is received in a preformed slot, removing the contact between this lip and the coating 16 may be enough to stop the wandering phenomenon even if the other lip remains in contact with the coating 16.

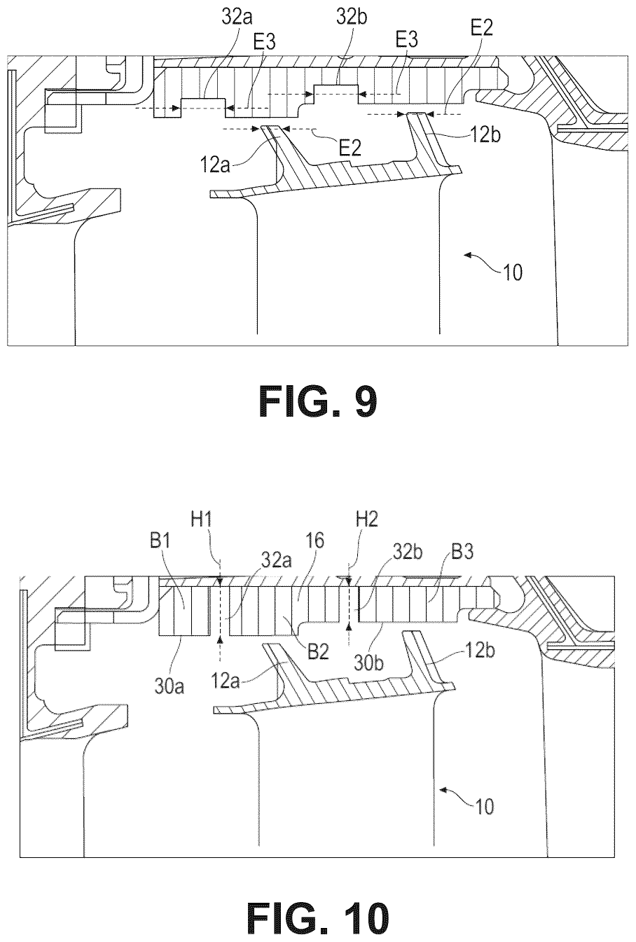

FIGS. 9 and 10 illustrate alternative versions of the device in which the dimensions of the slots 32a, 32b are adjusted. In FIG. 9, the axial dimensions E3 of the slots 32a, 32b are greater than those of the slots in FIG. 6a. E3 is, for example, greater than or equal to twice E2.

In the case of FIG. 10, the depths H1, H2 or radial dimensions of the slots 32a, 32b are greater than those of the slots in FIG. 6a. In addition, the slots extend over the entire thickness of the coating 16. As the surfaces 30a, 30b do not have the same diameter and the coating 16 comprises an external cylindrical surface of constant diameter which surrounds these surfaces 30a, 30b, the coating 16 does not have the same radial thickness throughout its axial extent. The slot 32a has a depth H1 greater than the depth H2 of the slot 32b.

In the case of FIG. 10, it can be seen that the coating 16 can be formed by the arrangement of three independent and successive annular blocks B1, B2 and B3 arranged axially one behind the other and at an axial distance from each other corresponding to the axial dimension of the slots 32a, 32b. The block B1 comprises an upstream part of the surface 30a, the block B2 comprises a downstream part of the surface 30a and an upstream part of the surface 30b, and the block B3 comprises a downstream part of the surface 30b. The blocks B1, B2 and B3 can be sectorised.

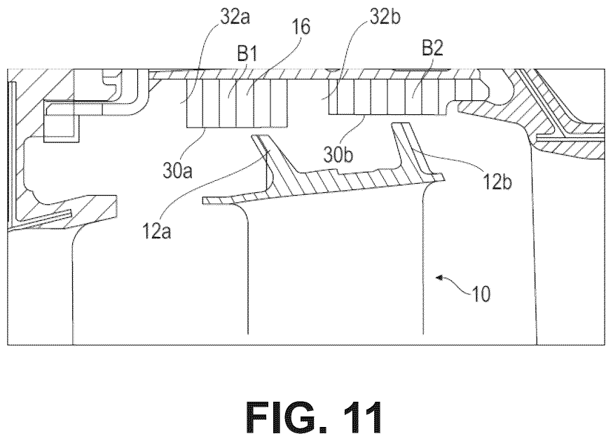

FIG. 11 differs from FIG. 10 in that the slots 32a, 32b are positioned even further upstream than the slots in FIG. 10. The slot 32b is thus located at the upstream axial end of the surface 30b, axially interposed between the surfaces 30a, 30b. The slot 32a is located at the upstream axial end of the surface 30a.

It can be seen that the coating 16 can be formed by the arrangement of two independent and successive annular blocks B1 and B2 arranged axially one behind the other and at an axial distance from each other corresponding to the axial dimension of the slot 32b. The block B1 comprises the surface 30a and the block B2 comprises the surface 30b. The blocks B1 and B2 can be sectorised.

The or each slot 32a, 32b can be formed in a coating by machining, for example. In the case of FIGS. 10 and 11, this machining step can be eliminated by using and positioning the aforementioned blocks.

The invention claimed is:

1. A labyrinth-type sealing device for an aircraft turbomachine, the device comprising:
a rotor having an axis of rotation and comprising external annular lips extending around said axis, and
a stator extending around the axis, this stator comprising an annular coating made of abradable material which extends around the lips and which is configured to cooperate in operation with the lips to form a labyrinth-type seal with respect to a flow of gas which is intended to flow axially from upstream to downstream through the rotor, the coating comprising an internal cylindrical surface extending around the lips and which is configured to contact the lips to form annular grooves extending around the axis by friction,
wherein the surface comprises, upstream of each of the lips, a preformed annular slot which extends around the axis and which is configured to receive said lip in the event of axial upstream displacement of the rotor with respect to the stator, a number of preformed slots being equal to a number of lips of the rotor.

2. The device according to claim 1, wherein the rotor comprises at least one upstream lip and one downstream lip, the upstream and downstream lips being surrounded by a same cylindrical surface of the coating or by two distinct cylindrical surfaces, respectively upstream and downstream, of the coating.

3. The device according to claim 2, wherein:
in the case where the upstream and downstream lips are surrounded by the same cylindrical surface of the coating, the cylindrical surface comprises a preformed slot upstream of the upstream lip, and/or a preformed slot upstream of the downstream lip, or
in the case where the upstream and downstream lips are surrounded by two distinct cylindrical surfaces, respectively upstream and downstream of the coating, the upstream cylindrical surface comprises a preformed slot upstream of the upstream lip, and/or the downstream cylindrical surface comprises a preformed slot upstream of the downstream lip.

4. The device according to claim 2, wherein the upstream and downstream cylindrical surfaces are stepped and comprise different diameters.

5. The device according to claim 4, wherein the slot is interposed axially between the two cylindrical surfaces.

6. The device according to claim 1, wherein each slot is located at an axial distance (L1) upstream of a corresponding lip, which is less than or equal to half the axial distance (L2) between the two lips.

7. The device according to claim 1, wherein each slot is located at an axial distance (L1) upstream of a corresponding lip, which is greater than half the axial distance (L2) between the two lips.

8. The device according to claim 6, wherein said axial distance (L1) is between 1 and 20 mm.

9. The device according to claim 1, wherein each slot has a radial depth or dimension (H1) less than or equal to a radial thickness or dimension of a zone of the coating in which this slot is formed.

10. The device according to claim 1, wherein each slot has an axial dimension (E1) greater than or equal to half an axial thickness (E2) of a corresponding lip, the thickness being measured at a level of an external periphery of this lip.

11. The device according to claim 1, wherein each slot is located at an axial distance from an upstream axial end of the cylindrical surface in which that slot is formed.

12. The device according to claim 1, wherein the rotor is a compressor or turbine blading, and the stator is a sealing ring carried by a casing of the compressor or turbine.

13. An aircraft turbomachine, comprising at least one of the device according to claim 1.

14. The device according to claim 8, wherein said axial distance (L1) is between 1 and 5 mm.
